(19) United States
(12) Patent Application Publication
(10) Pub. No.: US 2024/0111360 A1
(43) Pub. Date: Apr. 4, 2024

(54) OPERATION CONTROL DEVICE, OPERATION CONTROL SYSTEM, AND OPERATION CONTROL METHOD

(71) Applicant: Mitsubishi Electric Corporation, Tokyo (JP)

(72) Inventor: Tomoki WATANABE, Tokyo (JP)

(73) Assignee: Mitsubishi Electric Corporation, Tokyo (JP)

(21) Appl. No.: 18/285,730

(22) PCT Filed: Apr. 30, 2021
(86) PCT No.: PCT/JP2021/017163

§ 371 Date: Oct. 5, 2023

(51) Int. Cl. G06F 3/01; B60K 35/10; B60K 35/23; G06F 3/023; G06F 3/044

(52) U.S. Cl. CPC G06F 3/013; B60K 35/10; B60K 35/23; G06F 3/016; G06F 3/023; G06F 3/044; G06F 3/0414

(57) ABSTRACT

An operation control device includes processing circuitry configured to acquire, from a line-of-sight detection device, line-of-sight information indicating a line-of-sight of an operator on a touch display; detect a first touch state that indicates a physical touch by the operator on a display region of the touch display or a second touch state that indicates a physical touch by the operator on a knob for operation disposed in the display region; and decide an operation target by touch depending on the detected first or second touch state with reference to information, stored in advance, in which the first and second touch states and the operation target are associated with each other in a case where the first or second touch state is detected in a state in which the line-of-sight of the operator indicated in the acquired line-of-sight information is not directed toward the touch display.

### TECHNICAL FIELD

The present disclosure relates to an operation control device, an operation control system, and an operation control method for controlling operations on a touch display on which an operation knob is disposed.

### BACKGROUND ART

Conventionally, a so-called “knob-on touch display” has been used as an operation input device of electronic equipment such as in-vehicle information equipment. The knob-on touch display has a dial-like operation member (hereinafter, referred to as a “knob”) disposed in a region (hereinafter, referred to as a “display region”) in which an image can be displayed on a display surface of a display (hereinafter, referred to as a “touch display”) having a touch function.

In the conventional knob-on touch display, an operation target by the knob is switched by accepting an operation on a graphical user interface (GUI) displayed on the touch display (hereinafter, referred to as a “GUI operation”) or an operation on a push button provided around the display.

Meanwhile, Patent Literature 1 describes a configuration in which a predetermined operation is performed on a touch display (“touch panel” described in Patent Literature 1) of an in-vehicle information terminal to switch between a GUI operation for an image displayed in a display region and a user interface (UI) operation by movement of a finger tracing on the touch display.

### CITATION LIST

### Patent Literature

Patent Literature 1: Japanese Patent Laid-Open Publication No. 2005-82086

### SUMMARY OF INVENTION

### Technical Problem

In the in-vehicle knob-on touch display, for example, in a case where an operator is a driver and a vehicle is traveling, it is desirable that the operator switch the operation target without directing his/her line-of-sight to the display.

However, the conventional knob-on touch display has a problem that the operator tends to direct his/her line-of-sight to the display in order to surely execute a predetermined operation.

Also in the technology described in Patent Literature 1, since it is necessary to perform a predetermined operation on the touch display when switching between the GUI operation and the UI operation, the operator tends to direct his/her line-of-sight to the display as described above.

The present disclosure has been made to solve the above problems, and an object of the present disclosure is to provide an operation control device capable of guiding an operator not to direct his/her line-of-sight to a display when the operator performs an operation.

### Solution to Problem

An operation control device according to the present disclosure includes: a line-of-sight acquisition unit to acquire, from a line-of-sight detection device, line-of-sight information indicating a line-of-sight of an operator on a touch display; a touch detection unit to detect a touch state in which the operator touches a display region of the touch display or a knob for operation disposed in the display region; and an operation judgement unit to decide an operation target by touch depending on the detected touch state with reference to information, stored in advance, in which the touch state and the operation target are associated with each other in a case where the touch detection unit detects the touch state in a state in which the line-of-sight of the operator indicated in the line-of-sight information acquired by the line-of-sight acquisition unit is not directed toward the touch display.

### Advantageous Effects of Invention

According to the present disclosure, it is possible to provide an operation control device capable of guiding an operator not to direct her/his line-of-sight to a display when the operator performs an operation.

### BRIEF DESCRIPTION OF DRAWINGS

FIG. 1 is a diagram illustrating a configuration of an operation control system including an operation control device according to a first embodiment.

FIG. 2 is a view illustrating an example of an appearance of a knob-on touch display included in the operation control system.

FIG. 3 is a view illustrating a first example of a range in which a touch and a touch state are detected in a state where the line-of-sight of an operator is not directed to a touch display.

FIG. 4 is a view illustrating a second example of a range in which a touch and a touch state are detected in a state where the line-of-sight of the operator is not directed to a touch display.

FIG. 5 is an example of information stored in advance in the operation control device according to the first embodiment, in which a touch state and an operation target are associated with each other.

FIG. 6 is a flowchart illustrating an example of processing in the operation control device according to the first embodiment.

FIG. 7 is a diagram illustrating a configuration of an operation control system including an operation control device according to a second embodiment.

FIG. 8 is a view illustrating a third example of a range in which a touch and a touch state are detected in a state where the line-of-sight of the operator is not directed to a touch display.

FIG. 9 is a diagram illustrating a part of processing in the operation control device according to the second embodiment.

FIG. 10 is a diagram illustrating a configuration of an operation control system including an operation control device according to a third embodiment.

FIG. 11 is a view illustrating a first example of a touch state in the operation control device according to the third embodiment.

FIG. 12 is a view illustrating a second example of a touch state in the operation control device according to the third embodiment.

FIG. 13 is a first example of information stored in advance in the operation control device according to the third embodiment, in which a touch state and an operation target are associated with each other.

FIG. 14 is a second example of information stored in advance in the operation control device according to the third embodiment, in which a touch state and an operation target are associated with each other.

FIG. 15 is a diagram illustrating a part of processing in the operation control device according to the third embodiment.

FIG. 16 is a diagram illustrating a configuration of an operation control system including an operation control device according to a modification example of the third embodiment.

FIG. 17 is a diagram illustrating a first example of a hardware configuration for implementing the operation control device of the present disclosure.

FIG. 18 is a diagram illustrating a second example of a hardware configuration for implementing the operation control device of the present disclosure.

### DESCRIPTION OF EMBODIMENTS

Hereinafter, in order to explain the present invention in more detail, a mode for carrying out the present invention will be described with reference to the accompanying drawings.

### First Embodiment

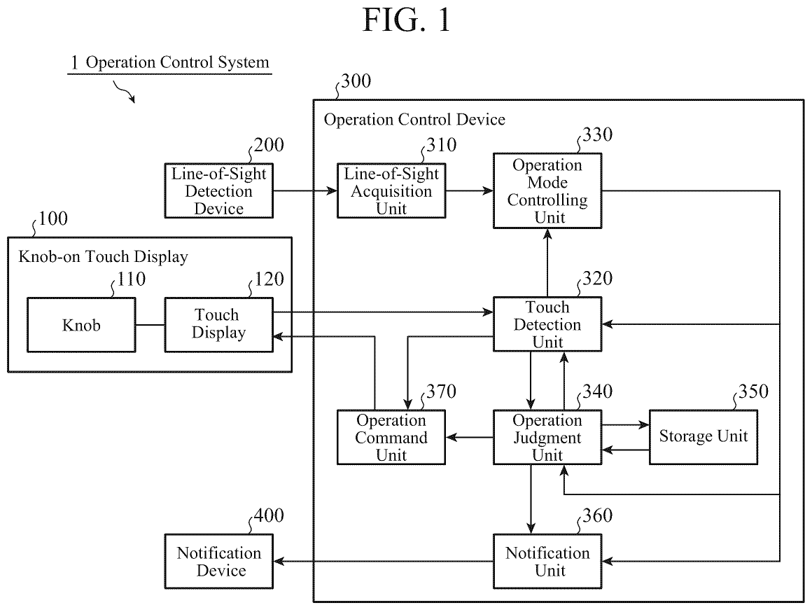

FIG. 1 is a diagram illustrating a configuration of an operation control system 1 including an operation control device 300 according to a first embodiment.

The operation control system 1 illustrated in FIG. 1 includes a knob-on touch display 100, a line-of-sight detection device 200, an operation control device 300, and a notification device 400.

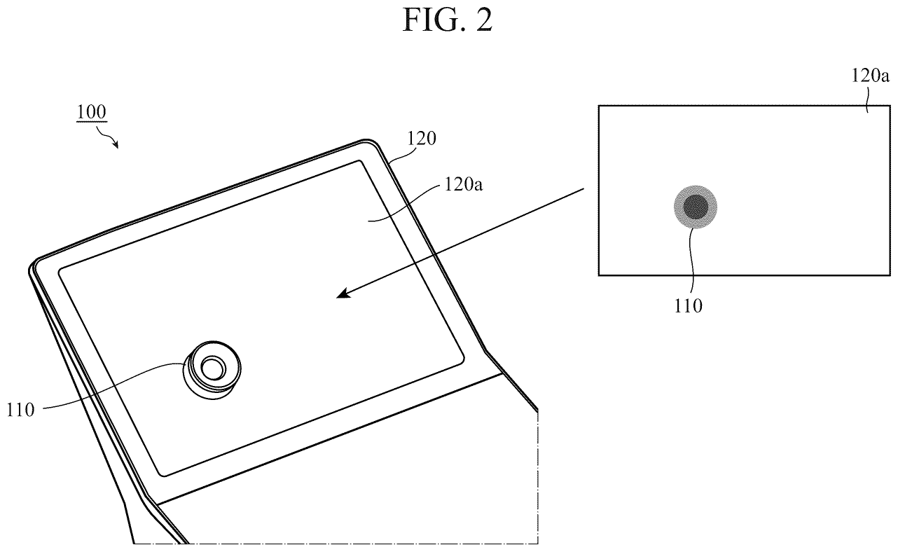

FIG. 2 is a view illustrating an example of an appearance of the knob-on touch display 100 included in the operation control system 1.

The knob-on touch display 100 has a knob 110 and a touch display 120.

In FIG. 2, the left side of FIG. 2 illustrates a state in which the appearance of the knob-on touch display 100 is viewed in a perspective manner, and the right side of FIG. 2 illustrates a state in which the display region of the knob-on touch display 100 is viewed from the front.

The knob-on touch display 100 illustrated in FIG. 2 is a display mounted on a mobile object, and will be described below particularly assuming an in-vehicle display. In a case of an in-vehicle display, the knob-on touch display 100 is installed, for example, between a driver's seat and a passenger's seat in the vehicle interior, at a position visually recognizable and operable from both a passenger (driver) seated in the driver's seat and a passenger seated in the assistant driver's seat.

However, the knob-on touch display 100 only needs to be installed at least at a position where the passenger of the mobile object can operate.

The touch display 120 is a display having a touch function. The touch display 120 has a display region on a display surface of the touch display 120. The display region is constituted by, for example, an electronic capacitive touch panel. In this case, the touch display 120 outputs a signal value indicating electrostatic capacitance at each position in the display region. By using this, a touch state in the display region of the touch display 120 can be judged.

The knob 110 is an operation device that accepts an operation of an operator.

The knob 110 is, for example, a dial-shaped member disposed in the display region of the display surface of the touch display 120.

The knob 110 is provided, for example, at a position where gripping by an operator is possible, and is rotatably provided in the display region. Furthermore, the knob 110 may be provided to be movable in the display region.

The knob 110 has, for example, a conductor grip portion (not illustrated), and has a plurality of conductor columns (not illustrated) inside the knob 110.

The grip portion is a member that the operator directly touches when operating. The plurality of conductor columns are members provided in contact with the grip portion.

When the operator touches the grip portion, the electrostatic capacitance in the display region of the touch display 120 is affected via each of the plurality of conductor columns.

By using this, it can be judged that the knob 110 has been touched.

The line-of-sight detection device 200 detects the line-of-sight of the operator and outputs information indicating the line-of-sight of the operator.

The line-of-sight detection device 200 is, for example, a driver monitoring system (DMS). In this case, for example, the line-of-sight detection device 200 captures an image of the operator with a camera (not illustrated) and detects the line-of-sight of the operator by analyzing the captured image.

The information indicating the line-of-sight of the operator is, for example, information such as the position of the eyes and the line-of-sight angle of the operator based on the position of the knob-on touch display. However, the information indicating the line-of-sight of the operator may be any information that can judge whether or not the operator is looking at the knob-on touch display in the processing in the operation control device 300.

Since the analysis processing for detecting the line-of-sight from the captured image can be implemented by using technology known in the art by the time of filing the present application, detailed description of the analysis processing is omitted.

Note that the line-of-sight detection device 200 in FIG. 1 may have an operator detection function for detecting the operator from among the passengers by detecting a hand approaching the display and a direction approaching the display in addition to analyzing the image and detecting the line-of-sight of the operator.

Furthermore, the line-of-sight detection device 200 having an operator detection function may detect the operator by using a detection result from a proximity sensor such as an infrared sensor in addition to the result of the image analysis processing.

If the operator can be detected, in the operation control device 300, for example, different operation targets can be decided depending on the seat position of the operator.

The operation control device 300 acquires, from the line-of-sight detection device 200, line-of-sight information indicating the line-of-sight of the operator on the touch display 120 and detects a touch state in which the operator touches the display region of the touch display 120 or the operation knob 110 disposed in the display region. In a case where the touch state is detected in a state in which the line-of-sight of the operator indicated by the line-of-sight information is not directed to the touch display 120, the operation control device decides an operation target to be touched depending on the detected touch state.

Then, the operation control device 300 controls the decided operation target depending on the touch operation.

Moreover, the operation control device 300 causes the notification device 400 to notify of the decided operation target.

The internal configuration of the operation control device 300 will be described later.

The notification device 400 notifies the operator or the passenger including the operator of the operation target decided by the operation control device 300.

The notification device 400 acquires operation target information indicating an operation target from the operation control device 300, and outputs an image indicating the operation target or sound indicating the operation target, or both of them indicated by the operation target information.

The notification device 400 is, for example, a head-up display, a speaker, or a display device. Moreover, the notification device 400 may be the touch display 120.

The notification device 400 may notify the operator by applying vibration. In this case, for example, if the touch display 120 is configured to be able to vibrate, the operator during the operation can know the change of the operation target when the finger during the operation receives vibration.

The internal configuration of the operation control device 300 will be described.

The operation control device 300 includes a line-of-sight acquisition unit 310, a touch detection unit 320, an operation mode controlling unit 330, an operation judgement unit 340, a storage unit 350, a notification unit 360, an operation command unit 370, and a control unit (not illustrated). The control unit (not illustrated) controls a flow of processing of each component in the operation control device 300.

The line-of-sight acquisition unit 310 acquires line-of-sight information indicating the line-of-sight of the operator of the touch display 120 from the line-of-sight detection device 200.

The line-of-sight acquisition unit 310 outputs the acquired line-of-sight information to the operation mode controlling unit 330.

The touch detection unit 320 detects a touch state in which the operator touches the display region of the touch display 120 or the operation knob 110 disposed in the display region.

Specifically, when detecting a touch state in which the operator touches the display region or the knob 110 in a situation where the operation mode controlling unit 330 decides the normal mode, the touch detection unit 320 outputs a touch signal, which indicates the touch, to the operation mode controlling unit 330.

Moreover, the touch detection unit 320 detects a touch state in which the operator touches the display region in a state where mode information indicating a blind operation mode is received from the operation mode controlling unit 330, and outputs the touch state information, which indicates the touch state, to the operation judgement unit 340.

Note that the touch detection unit 320 can detect a touch state on the display region or can detect a touch state on the knob 110. This is because whether the touched target is the knob 110 or the display region can be discriminated by using the position of the conductor of the knob 110 in the state where the knob 110 is touched.

The touch state detected by the touch detection unit 320 includes the following examples.

Examples include a state in which the operator's finger simply touches the display region or the knob 110, a position in the display region touched by the operator, the number of positions in the display region touched by the operator, the number of consecutive touches on the display region or the knob 110, a pressure for each position in the display region touched by the operator, and an area for each position in the display region touched by the operator.

Furthermore, examples include a state in which the operator's finger traces the display region, a state in which the operator's finger taps the display region, a state in which the knob 110 is gripped by the operator, a state in which the knob 110 is moved to change the position, and a state in which the knob 110 is rotated.

When the operator touches the display region of the touch display 120 or the operation knob 110 disposed in the display region in a state in which the line-of-sight of the operator is not directed to the touch display 120, the operation mode controlling unit 330 switches the mode of the touch operation on the display region of the touch display 120 or the knob 110.

Specifically, the operation mode controlling unit 330 receives the line-of-sight information from the line-of-sight acquisition unit 310, and uses the line-of-sight information to judge whether or not the line-of-sight of the operator is directed to the knob-on touch display 100.

When judging that the line-of-sight is not directed to the knob-on touch display 100, the operation mode controlling unit 330 acquires a touch signal from the touch detection unit 320 and judges whether or not the touch detection unit 320 has detected a touch by using the touch signal.

When judging that a touch is detected, the operation mode controlling unit 330 decides the blind operation mode as the operation mode, and notifies the touch detection unit 320, the operation judgement unit 340, and the notification unit 360 of the mode information indicating the decided operation mode.

Herein, the mode of the touch operation includes, for example, a normal operation mode and a blind operation mode.

The normal operation mode is, for example, a mode in which an operation for a general GUI can be performed.

The blind operation mode is, for example, a mode for deciding an operation target in a touch state by the operator in a state where the line-of-sight of the operator is not directed to the touch display 120.

In a case where the touch detection unit 320 detects a touch state in a state in which the line-of-sight of the operator, which is indicated by the line-of-sight information acquired by the line-of-sight acquisition unit 310 is not directed to the touch display 120, the operation judgement unit 340 refers to information stored in advance and associating the touch state with the operation target, and decides the operation target by touch depending on the detected touch state.

Specifically, the operation judgement unit 340 acquires touch state information from the touch detection unit 320 and decides an operation target by touch with reference to information in which a touch state and an operation target are associated, stored in a storage unit 350 to be described later, by using the touch state information.

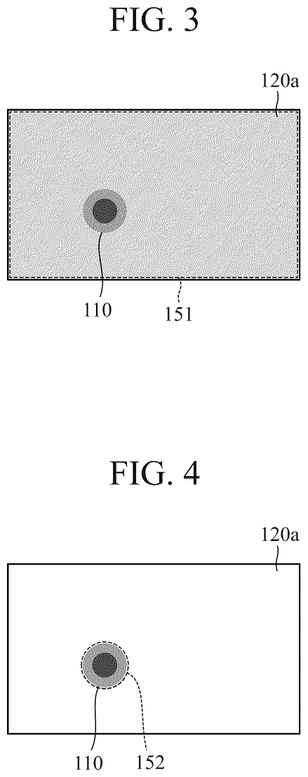

FIG. 3 is a view illustrating a first example (detection range 151) of a range in which a touch and a touch state are detected in a state where the line-of-sight of the operator is not directed to the touch display 120.

The detection range 151 is an entire display region 120a of the touch display 120.

In this case, when the operator touches the inside of the display region 120a of the touch display 120 in a state where the line-of-sight of the operator is not directed to the touch display 120, the operation judgement unit 340 adopts the touch state with respect to the display region 120a.

The operation judgement unit 340 decides an operation target depending on the adopted touch state.

FIG. 4 is a view illustrating a second example (detection range 152) of a range in which a touch and a touch state are detected in a state where the line-of-sight of the operator is not directed to the touch display 120.

The detection range 152 is the knob 110.

In this case, when the operator touches the knob 110 in a state where the line-of-sight of the operator is not directed to the touch display 120, the operation judgement unit 340 adopts the touch state with respect to the knob 110.

The operation judgement unit 340 decides an operation target depending on the adopted touch state.

Specific examples of the touch state and the operation target will be described later.

The storage unit 350 stores information in which a touch state and an operation target are associated with each other.

The information in which the touch state and the operation target are associated with each other is stored in advance in the storage unit 350 before the operation judgement unit 340 decides the operation target.

Herein, the touch state and the operation target will be described.

Examples of the touch state include types such as a touch position, the number of touch positions, the number of touches, a touch position pressure, and a touch position area.

The touch position is a position touched by the operator in the display region of the touch display 120. This can be indicated, for example, by the coordinates of the display region.

The number of touch positions is the number of positions touched by the operator in the display region of the touch display 120. This corresponds to, for example, the number of fingers of the touching operator.

The number of touches is the number of times the operator consecutively touches the display region of the touch display 120 or the knob 110 within a predetermined time.

The touch position pressure is a pressure for each position touched by the operator in the display region of the touch display 120.

The touch position area is an area for each position touched by the operator in the display region of the touch display 120. In a case of using the touch position area, when a fingerprint is further detected by another sensor (not illustrated) and the fingerprint and the touch position area are used in combination, the operation target can be decided by using the type of the touched finger.

The operation target is not particularly limited, but is preferably a function that does not require a complicated operation in order to prevent the operator from directing his/her line-of-sight to the display.

Moreover, the operation target is preferably a function that is frequently used by the operator.

Such an operation target includes, for example, a function of in-vehicle equipment and a function of changing a numerical value to large or small. Specific examples thereof include temperature setting for in-vehicle air conditioning equipment, air volume setting for in-vehicle air conditioning equipment, sound volume setting for in-vehicle acoustic equipment, music forwarding for in-vehicle acoustic equipment, and channel selection for in-vehicle broadcast receiving equipment.

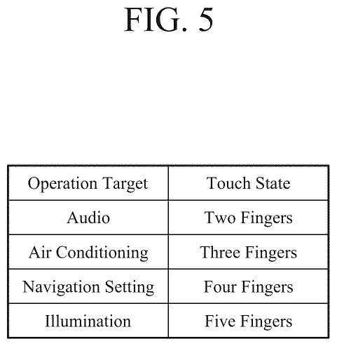

FIG. 5 is an example of information stored in advance in the operation control device 300 according to the first embodiment, in which a touch state and an operation target are associated with each other.

FIG. 5 illustrates a case where “the number of touch positions” is used as the touch state.

In the example illustrated in FIG. 5, the operation target “audio” and the touch state “two fingers” are associated with each other. Similarly, the operation target “air conditioning” is associated with the touch state “three fingers”, and similarly, the operation target “navigation setting” is associated with the touch state “four fingers”. Similarly, the operation target “illumination” and the touch state “five fingers” are associated with each other.

In this case, when the operator touches the display region with two fingers, the operation target is decided to be a function of setting the sound volume of “audio”, for example. Subsequently, for example, when the operator makes a touch state tracing upward in the display region, a numerical value indicating the sound volume is operated to increase, and when the operator makes a touch state tracing downward in the display region, a numerical value indicating the sound volume is operated to decrease.

The notification unit 360 outputs a notification signal for notifying the operator of the operation target decided by the operation judgement unit 340 via the notification device 400.

Moreover, for example, the notification unit 360 outputs a notification signal for displaying the operation target decided by the operation judgement unit 340 on a head-up display mounted on the vehicle.

Furthermore, for example, when the operation judgement unit 340 decides an operation target and the operation target changes, the notification unit 360 outputs a notification signal for vibrating the touch display 120.

Furthermore, the notification unit 360 may make a notification by combining these.

When the operation judgement unit 340 decides an operation target, the operation command unit 370 outputs an operation command signal related to the operation target depending on a touch state further detected by the touch detection unit 320.

Specifically, for example, upon receiving a notification of an operation target from the operation judgement unit 340 and subsequently receiving touch state information indicating a touch state from the touch detection unit 320, the operation command unit 370 generates and outputs a command signal indicating operation content for the operation target using the operation target and the touch state information.

Next, processing of the operation control device 300 will be described.

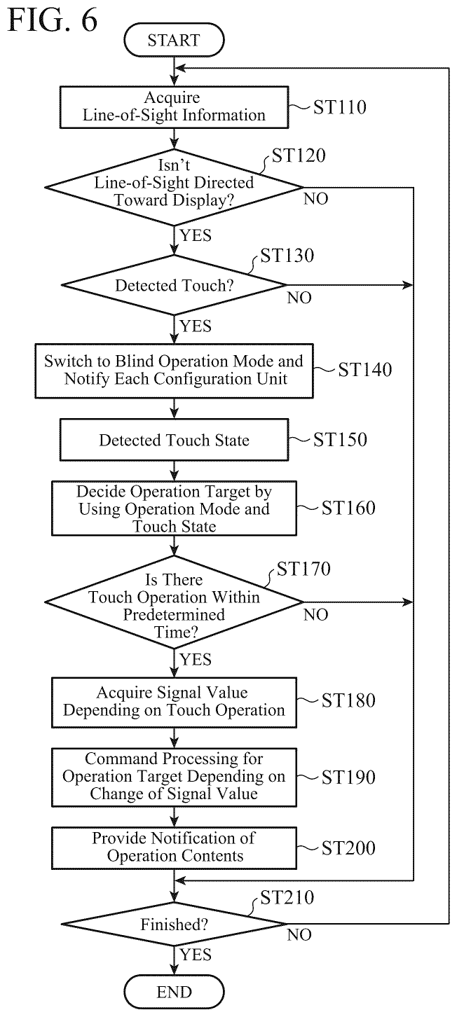

FIG. 6 is a flowchart illustrating an example of processing in the operation control device 300 according to the first embodiment.

For example, when the knob-on touch display 100 is powered on, the operation control device 300 starts processing (Start).

The line-of-sight acquisition unit 310 acquires the line-of-sight information from the line-of-sight detection device 200 (Step ST110).

The line-of-sight acquisition unit 310 outputs the acquired line-of-sight information to the operation mode controlling unit 330.

The operation mode controlling unit 330 receives the line-of-sight information from the line-of-sight acquisition unit 310 and uses the line-of-sight information to judge whether or not the line-of-sight of the operator is directed to the knob-on touch display 100 (Step ST120).

In a case where the operation mode controlling unit 330 judges that the line-of-sight of the operator is directed to the knob-on touch display 100 (Step ST120 “NO”), the processing of the operation control device 300 proceeds to Step ST210.

In a case where that the line-of-sight is judged to be not directed to the knob-on touch display 100 (Step ST120 “YES”), the operation mode controlling unit 330 judges whether the touch detection unit 320 has detected a touch (Step ST130).

Specifically, when acquiring touch information from the touch detection unit 320, the operation mode controlling unit 330 judges that a touch has been detected.

In a case where the operation mode controlling unit 330 judges that no touch has been detected (Step ST130 “NO”), the processing of the operation control device 300 proceeds to Step ST210.

In a case where a touch has been detected (“YES” in Step ST130), the operation mode controlling unit 330 switches to the blind operation mode and notifies each component of the mode (Step ST140).

Specifically, the operation mode controlling unit 330 notifies the touch detection unit 320, the operation judgement unit 340, and the notification unit 360 of the mode information indicating the decided blind operation mode.

When receiving the notification indicating the blind operation mode, the touch detection unit 320 detects a touch state (Step ST150) and outputs, to the operation judgement unit 340, the touch state information indicating the touch state.

When receiving the notification indicating the blind operation mode and the touch state information, the operation judgement unit 340 decides an operation target by using the touch state indicated by the touch state information (Step ST160).

Specifically, the operation judgement unit 340 decides the operation target by referring to information in which the touch state and the operation target are associated in the storage unit 350 by using the touch state indicated in the touch state information.

The operation judgement unit 340 notifies the touch detection unit 320, the notification unit 360, and the operation command unit 370 of the decided operation target.

The control unit (not illustrated) determines whether or not a touch operation has been performed within a predetermined time in the touch detection unit 320 (Step ST170).

In a case where there is no touch operation within the predetermined time (Step ST170 “NO”), the processing of the operation control device 3M) proceeds to Step ST210 by the control unit (not illustrated).

In a case where the control unit (not illustrated) determines that a touch operation has been performed within a predetermined time (Step ST170 “YES”), the operation command unit 370 acquires a signal value depending on the touch operation from the touch detection unit 320 (Step ST180).

The operation command unit 370 outputs a command signal that commands processing depending on a change in a signal value to the operation target (Step ST190).

The notification unit 36) provides a notification of the operation content (Step ST200).

Subsequently, the control unit (not illustrated) judges whether to finish the operation control processing (Step ST210).

In a case where the control unit (not illustrated) determines that the processing has not been finished (Step ST210 “NO”), the processing of the operation control device 300 proceeds to Step ST110.

In a case where the control unit (not illustrated) determines that the process has been finished (Step ST210 “YES”), the operation control processing in the operation control device 300 ends (End).

With the above-described configuration and processing, the operation control device 300 can decide an operation target depending on a touch state by touching the knob-on touch display in a state where the operator is not directing his/her line-of-sight to the knob-on touch display. Therefore, regardless of the vehicle speed, it is possible to guide the passenger of the mobile object not to direct her/his line-of-sight when the passenger of the mobile object is to operate the knob-on touch display.

An operation control device according to the present disclosure includes: a line-of-sight acquisition unit configured to acquire, from a line-of-sight detection device, line-of-sight information indicating a line-of-sight of an operator on a touch display; a touch detection unit configured to detect a touch state in which the operator touches a display region of the touch display or an operation knob disposed in the display region; and an operation judgement unit configured to decide an operation target by touch depending on the detected touch state with reference to information that is stored in advance and in which the touch state and the operation target are associated with each other in a case where the touch detection unit detects the touch state in a state in which the line-of-sight of the operator indicated in the line-of-sight information acquired by the line-of-sight acquisition unit is not directed toward the touch display.

Accordingly, there is an effect of providing an operation control device that can guide the operator not to direct his/her line-of-sight to the display when the operator performs an operation.

The operation control device according to the present disclosure is further configured in such a manner that the touch state includes a position touched by the operator in the display region.

Accordingly, there is an effect that an operation control device, which decides an operation target depending on a position of a finger touched by an operator, can be provided.

The operation control device according to the present disclosure is further configured in such a manner that the touch state includes the number of positions touched by the operator in the display region.

Accordingly, there is an effect that an operation control device, which decides an operation target depending on the number of fingers touched by an operator, can be provided.

The operation control device according to the present disclosure is further configured in such a manner that the touch state includes pressure for each position touched by the operator in the display region.

Accordingly, there is an effect that an operation control device, which decides an operation target depending on the pressure of fingers touched by an operator, can be provided.

The operation control device according to the present disclosure is further configured in such a manner that the touch state includes an area for each position touched by the operator in the display region.

Accordingly, there is an effect that an operation control device, which decides an operation target depending on the areas of fingers touched by an operator, can be provided.

The operation control device according to the present disclosure is further configured in such a manner that the touch state is the number of times of consecutive touches by the operator on the display region or the knob.

Accordingly, there is an effect that an operation control device, which decides an operation target depending on the number of touches of fingers tapped by an operator, can be provided.

The operation control device according to the present disclosure further includes an operation command unit that outputs an operation command signal related to an operation target depending on a touch state further detected by the touch detection unit when the operation judgement unit decides the operation target.

Accordingly, there is an effect that it is possible to provide an operation control device capable of performing a touch operation on the decided operation target.

The operation control device according to the present disclosure further includes a notification unit that outputs a notification signal for notifying the operator of the operation target decided by the operation judgement unit.

Accordingly, there is an effect that it is possible to provide an operation control device capable of performing a touch operation on the decided operation target.

The operation control device according to the present disclosure is further configured in such a manner that the notification unit outputs a notification signal for vibrating the touch display when the operation judgement unit decides the operation target and the operation target changes.

Accordingly, there is an effect that an operation control device, which can guide the operator so as not to direct her/his line-of-sight to the touch display, can be provided.

The operation control device according to the present disclosure is further configured in such a manner that the notification unit outputs a notification signal for causing a head-up display mounted on the vehicle to display the operation target decided by the operation judgement unit.

Accordingly, there is an effect that an operation control device, which can guide the operator so as not to direct her/his line-of-sight to the touch display, can be provided.

The operation control device according to the present disclosure is further configured in such a manner that the operation target is a function of in-vehicle equipment, and is a function of changing a numerical value to large or small.

Accordingly, there is an effect that an operation control device, which is easy for an operator to operate by a touch operation, can be provided.

The operation control device according to the present disclosure is further configured in such a manner that the operation target is a function of setting at least one of temperature setting for the air conditioning equipment, sound volume setting for the acoustic equipment, channel selection for the broadcast receiving equipment, or brightness of illumination.

Accordingly, there is an effect that an operation control device, which is easy for an operator to operate an operation target frequently utilized in a mobile object by a touch operation, can be provided.

An operation control system according to the present disclosure includes: an in-vehicle touch display: a display region of the touch display or an operation knob disposed in the display region; and an operation control device configured to command an operation target depending on a touch state of an operator on the touch display or the knob, in which the operation control device includes: a line-of-sight acquisition unit configured to acquire line-of-sight information indicating a line-of-sight of the operator on the touch display from a line-of-sight detection device; a touch detection unit configured to detect a touch state in which the operator touches the display region of the touch display or the operation knob disposed in the display region; and an operation judgement unit configured to decide an operation target by touch depending on the detected touch state with reference to information that is stored in advance and in which the touch state and the operation target are associated with each other in a case where the touch detection unit detects the touch state in a state in which the line-of-sight of the operator indicated in the line-of-sight information acquired by the line-of-sight acquisition unit is not directed toward the touch display.

Accordingly, there is an effect that an operation control system that can guide the operator not to direct his/her line-of-sight to the display when the operator performs an operation.

An operation control method according to the present disclosure is an operation control method for an operation control device configured to command an operation target depending on a touch state of an operator on a display region of a touch display or an operation knob disposed in the display region, in which a line-of-sight acquisition unit of the operation control device acquires line-of-sight information indicating a line-of-sight of the operator of the touch display from a line-of-sight detection device, a touch detection unit of the operation control device detects a touch state in which the operator touches a display region of the touch display or the operation knob disposed in the display region, and an operation judgement unit of the operation control device decides an operation target by touch depending on the detected touch state by referring to information stored in advance and in which the touch state is associated with the operation target in a case where the touch detection unit detects the touch state in a state in which the line-of-sight of the operator indicated in the line-of-sight information acquired by the line-of-sight acquisition unit is not directed toward the touch display.

Accordingly, there is an effect of providing an operation control method that can guide the operator not to direct his/her line-of-sight to the display when the operator performs an operation.

### Second Embodiment

In the first embodiment, a mode is described in which the operation target is switched depending on the detected touch state when the touch state of the display region or the knob 110 is detected.

On the other hand, in a second embodiment, a mode will be described in which an operation target is switched depending on a detected touch state when a touch state is detected subsequently after a knob 110′ is touched.

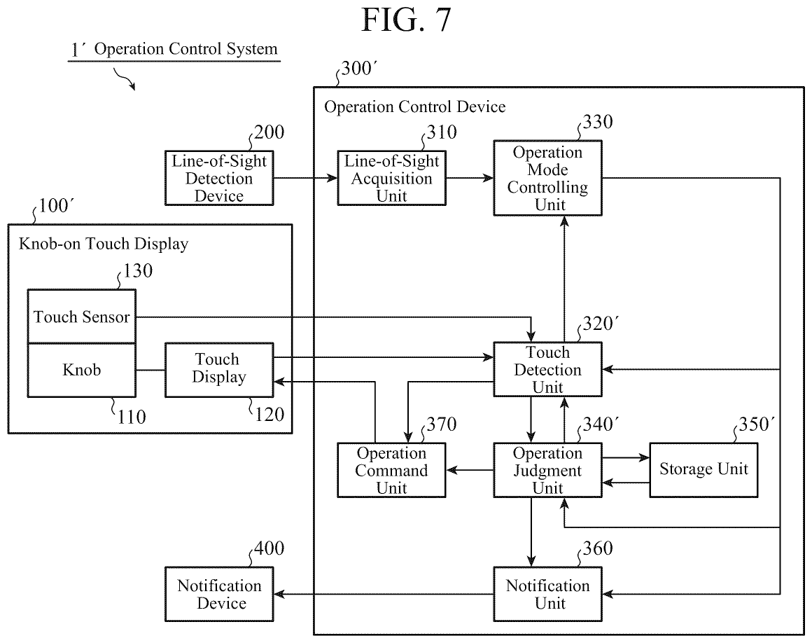

FIG. 7 is a diagram illustrating a configuration of an operation control system 1′ including an operation control device 300′ according to the second embodiment.

The operation control system 1′ illustrated in FIG. 7 is different from the operation control system 1 illustrated in FIG. 1 in that the knob-on touch display is changed to a knob-on touch display 100′, and similarly, the operation control device 300 is changed to an operation control device 300′.

In the description, a configuration changed from that in FIG. 1 will be described in detail, and description of a configuration similar to the configuration already described will be omitted as appropriate.

The operation control system 1′ illustrated in FIG. 7 includes the knob-on touch display 100′, a line-of-sight detection device 200′, the operation control device 300′, and a notification device 400.

Since the line-of-sight detection device 200 and the notification device 400 are similar to the line-of-sight detection device 200 and the notification device 400 illustrated in FIG. 1, respectively, the description thereof will be omitted.

The knob-on touch display 100′ is provided with a touch sensor 130 in addition to the configuration of the knob-on touch display 100 in FIG. 1.

The touch sensor 130 is a sensor that detects a state (touch state) in which the knob 110 is touched by the operator. The touch sensor 130 outputs a signal indicating a touch state.

The state in which the knob 110 is touched by the operator includes, for example, a touched position, the number of touched positions, the number of touched times, a pressure for each touched position, and an area for each touched position.

The touch sensor 130 is a sensor in which a known sensor technology is appropriately utilized depending on a touch state that can be used in the present disclosure.

The operation control device 300′ includes a line-of-sight acquisition unit 310, a touch detection unit 320′, an operation mode controlling unit 330, an operation judgement unit 340′, a storage unit 350′, a notification unit 360, and an operation command unit 370.

The line-of-sight acquisition unit 310, the operation mode controlling unit 330, the notification unit 360, and the operation command unit 370 are similar to the line-of-sight acquisition unit 310, the operation mode controlling unit 330, the notification unit 360, and the operation command unit 370 illustrated in FIG. 1, respectively, and thus detailed description thereof will be omitted.

The touch detection unit 320′ uses a signal from a touch sensor 130 provided on the knob 110 to detect a touch state in which the operator is touching the knob 110 and to detect a touch state in which the operator is touching the display region of a touch display 120.

Specifically, in a state where the operation mode controlling unit 330 decides the normal operation mode, the touch detection unit 320′ receives a touch signal, which indicates that the touch has been made, from the touch sensor 130.

When the touch detection unit 320′ detects a touch state in which the operator is touching the knob 110 and then detects a touch state in which the operator is touching the touch display 120 within a predetermined time, the touch detection unit 320′ outputs a touch signal, which indicates the touch, to the operation mode controlling unit 330.

The touch detection unit 320′ detects a touch state in which the operator touches the display region in a state where the mode information indicating the blind operation mode is received from the operation mode controlling unit 330, and outputs the touch state information, which indicates the touch state, to the operation judgement unit 340′.

The touch state used in the second embodiment is different from the touch state used in the first embodiment in that there are many touch states for the knob 110 depending on the touch sensor 130.

That is, the touch state detected by the touch detection unit 320′ includes the following examples.

Examples of a touch state include a state in which the operator's finger simply touches the display region or the knob 110, a position on the display region or the knob 110 touched by the operator, the number of positions on the display region or the knob 110 touched by the operator, the number of consecutive touches on the display region or the knob 110, a pressure for each position on the display region or the knob 110 touched by the operator, and an area for each position on the display region or the knob 110 touched by the operator.

Furthermore, examples of the touch state include a state in which the operator's finger traces the display region, a state in which the operator's finger taps the display region, a state in which the knob 110 is gripped by the operator, a state in which the knob 110 is moved to change the position, and a state in which the knob 110 is rotated. In a case where the touch detection unit 320′ detects a touch state on the knob 110 and then the touch detection unit 320′ detects a touch state on the display region in a state where the line-of-sight of the operator indicated by the line-of-sight information acquired by the line-of-sight acquisition unit 310 is not directed to the touch display 120, the operation judgement unit 340′ decides an operation target depending on the touch state on the display region.

Therefore, the operator first positions the finger by touching the knob 110, and then touches the display region, so that the operator can easily touch in the intended touch state.

When the operation judgement unit 340′ acquires, from the touch detection unit 320′, a touch state in which the operator touches the knob 110 in a state in which the line-of-sight of the operator indicated by the line-of-sight information acquired by the line-of-sight acquisition unit 310 is not directed to the touch display 120, the operation judgement unit 340′ may be not adopt a touch state for a region other than a part of the display region of the touch display 120 including the region where the knob 110 is disposed.

Thus, in a case where there is a plurality of operators to operate, even if the operator tries to perform the touch operation on the display region at the same timing, the operation of the operator who touches the knob 110 can be prioritized.

The storage unit 350′ stores information in which a touch state and an operation target are associated with each other.

The information, in which the touch state and the operation target are associated with each other, is stored in advance in the storage unit 350′ before the operation judgement unit 340′ decides the operation target.

Herein, the touch state and the operation target will be described.

The touch state and the operation target used in the operation control device 300′ of the second embodiment are different from the touch state and the operation target in the first embodiment in that the touch state with respect to the knob 110 increases.

That is, examples of the touch state and the operation target used in the operation control device 300′ of the second embodiment are as follows.

Examples of the touch state include types such as a touch position, the number of touch positions, the number of touches, a touch position pressure, and a touch position area.

The touch position is a position touched by the operator in the display region of the touch display 120 or the knob 110. This can be indicated, for example, by the coordinates of the display region.

The number of touch positions is the number of positions touched by the operator in the display region of the touch display 120 or the knob 110. This corresponds to, for example, the number of fingers of the touching operator.

The number of touches is the number of times the operator consecutively touches the display region of the touch display 120 or the knob 110 within a predetermined time.

The touch position pressure is a pressure for each position touched by the operator in the display region of the touch display 120 or the knob 110.

The touch position area is an area for each position touched by the operator in the display region of the touch display 120 or the knob 110. In a case of using the touch position area, when a fingerprint is further detected by another sensor (not illustrated) and the fingerprint and the touch position area are used in combination, the operation target can be decided by using the type of the touched finger.

Since the operation target is similar to the content described in the first embodiment, a detailed description of the operation target is omitted.

An example of the detection range of the touch and the touch state in the operation control device 300′ of the second embodiment is the detection range 152 of FIG. 4 described in the first embodiment.

In addition, the following detection ranges can be considered.

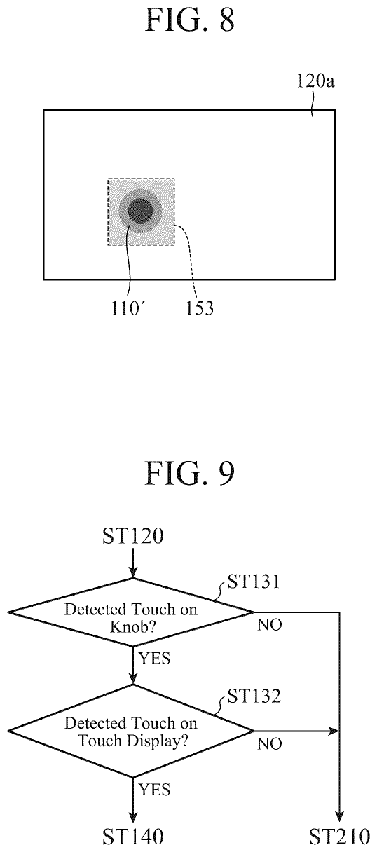

FIG. 8 is a view illustrating a third example (detection range 153) of a range in which a touch and a touch state are detected in a state where the line-of-sight of the operator is not directed to the touch display 120.

The detection range 153 is a range around knob 110 and knob 110.

FIG. 9 is a diagram illustrating a part of processing in the operation control device 300′ according to the second embodiment.

The processing of the operation control device 300′ according to the second embodiment is obtained by changing Step ST130 in the flowchart of FIG. 6 described in the first embodiment to Steps ST131 and ST132 illustrated in FIG. 9.

Hereinafter. Steps ST131 and ST132 will be mainly described, and description of processing similar to the processing described in the first embodiment will be omitted.

In a case where it is judged that the line-of-sight is not directed to the touch display 120 in Step ST120 illustrated in FIG. 6 (Step ST120 “YES”), the operation control device 300′ according to the second embodiment proceeds to processing in Step ST131.

The operation judgement unit 340′judges whether the touch detection unit 320′ has detected a touch on the knob 110 (Step ST131).

In a case where it is determined that the touch detection unit 320′ has not detected a touch on the knob 110 (Step ST131 “NO”), the processing of the operation control device 300′ proceeds to Step ST210.

In a case where it is judged that the touch detection unit 320′ has detected a touch on the knob 110 (“YES” in Step ST131), the operation judgement unit 340′ judges whether or not a touch on the touch display 120 has been detected (Step ST132).

Specifically, in a case where it is judged that a touch on the knob 110 has been detected, the operation judgement unit 340′ further judges whether or not a touch on the touch display 120 has been detected within a predetermined time stored in advance.

In a case where the operation judgement unit 340′judges that a touch on the touch display 120 is not detected (Step ST132 “NO”), the processing of the operation control device 300′ proceeds to Step ST210 illustrated in FIG. 6.

In a case where the operation judgement unit 340′ judges that a touch on the touch display 120 has been detected (Step ST132 “YES”), the processing of the operation control device 300′ proceeds to Step ST140 illustrated in FIG. 6.

The operation control device according to the present disclosure is further configured in such a manner that the touch detection unit detects a touch state in which the operator touches the knob by using a signal from the touch sensor 130 provided on the knob and detects a touch state in which the operator touches the display region of the touch display, and the operation judgement unit decides the operation target depending on the touch state on the display region in a case where the touch detection unit detects the touch state on the display region after the touch detection unit detects the touch state on the knob.

Accordingly, first, the operator positions the finger by touching the knob, and then touches the display region. Therefore, there is an effect that the operation control device can be provided in which the operator can easily touch in an intended touch state.

In the operation control device according to the present disclosure, the operation judgement unit is further configured not to adopt a touch state for a region other than a part of a display region of the touch display including a region in which the knob is disposed, when acquiring, from the touch detection unit, a touch state in which the operator touches the knob in a state in which the line-of-sight of the operator is not directed toward the touch display.

Thus, in a case where there is a plurality of operators to operate, even if the operators try to perform the touch operation on the display region at the same timing, the operation of the operator who touches the knob can be prioritized.

The operation control device according to the present disclosure is further configured in such a manner that the touch state includes a position touched by the operator on the display region or the knob.

Accordingly, there is an effect that an operation control device, which decides an operation target depending on a position of a finger touched by an operator, can be provided.

The operation control device according to the present disclosure is further configured in such a manner that the touch state includes the number of positions touched by the operator on the display region or the knob.

Accordingly, there is an effect that an operation control device, which decides an operation target depending on the number of fingers touched by an operator, can be provided.

The operation control device according to the present disclosure is further configured in such a manner that the touch state includes pressure for each position touched by the operator on the display region or the knob.

Accordingly, there is an effect that an operation control device, which decides an operation target depending on the pressure of fingers touched by an operator, can be provided.

The operation control device according to the present disclosure is further configured in such a manner that the touch state includes an area for each position touched by the operator on the display region or the knob.

Accordingly, there is an effect that an operation control device, which decides an operation target depending on the pressure of fingers touched by an operator, can be provided.

The operation control device according to the present disclosure is further configured in such a manner that the touch state is the number of times of consecutive touches by the operator on the display region or the knob.

Accordingly, there is an effect that an operation control device, which decides an operation target depending on the number of touches of fingers tapped by an operator, can be provided.

### Third Embodiment

In the first and second embodiments, the mode, in which the operation target is decided depending on touch state for each type such as the touch position, the number of touches, and the touch pressure in the display region, has been described.

On the other hand, in a third embodiment, a mode, in which an operation target is decided by a combination of each touch state and a touch state of a type different from each touch state will be further described.

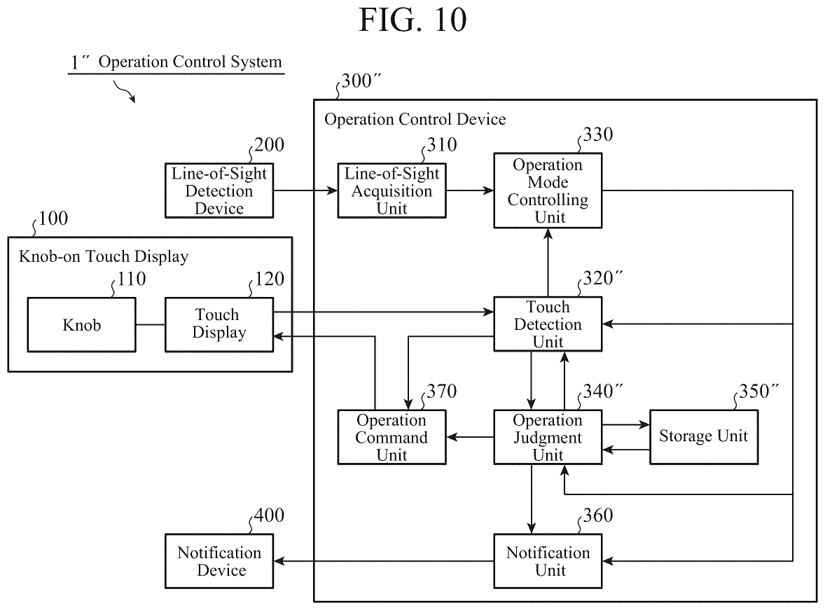

FIG. 10 is a diagram illustrating a configuration of an operation control system 1″ including an operation control device 300″ according to the third embodiment.

The operation control system 1″ illustrated in FIG. 10 is different from the operation control system 1 illustrated in FIG. 1 in that the operation control device 300 is changed to an operation control device 300″.

In the description, a configuration changed from that in FIG. 1 will be described in detail, and description of a configuration similar to the configuration already described will be omitted as appropriate.

The operation control system 1″ illustrated in FIG. 10 includes a knob-on touch display 100′, a line-of-sight detection device 200, an operation control device 300″, and a notification device 400.

The knob-on touch display 100, the line-of-sight detection device 200, and the notification device 400 illustrated in FIG. 10 are similar to the knob-on touch display 100, the line-of-sight detection device 200, and the notification device 400 illustrated in FIG. 1, respectively, and thus description thereof is omitted.

The operation control device 300″ includes a line-of-sight acquisition unit 310, a touch detection unit 320″, an operation mode controlling unit 330, an operation judgement unit 340″, a storage unit 350″, a notification unit 360, and an operation command unit 370.

The line-of-sight acquisition unit 310, the operation mode controlling unit 330, the notification unit 360, and the operation command unit 370 are similar to the line-of-sight acquisition unit 310, the operation mode controlling unit 330, the notification unit 360, and the operation command unit 370 illustrated in FIG. 1, respectively, and thus detailed description thereof will be omitted.

The touch detection unit 320″ in the third embodiment is different from the touch detection units of other embodiments in that the following touch states are detected.

The operation judgement unit 340″ in the third embodiment is different from the operation judgement units of other embodiments in that an operation target is decided by using the following touch states.

The storage unit 350″ in the third embodiment is different from the storage units of other embodiments in that an operation target is associated with the following touch states.

Herein, the touch state and the operation target will be described.

Examples of the touch state used in the third embodiment include a combination of a touch position and the number of touch positions, and a combination of the number of touch positions and the number of touches.

The combination of the touch position and the number of touch positions indicates arrangement states of a plurality of positions touched by the operator.

The combination of the number of touch positions and the number of touches indicates the number of consecutive touches at a plurality of positions touched by the operator.

Furthermore, for example, a combination of the number of touch positions and a touch position pressure, or a combination of the number of touch positions and a touch position area may be used.

Since the operation target is similar to the content described in the first embodiment, a detailed description of the operation target is omitted.

Specific examples of a touch state and an operation target in the third embodiment will be described.

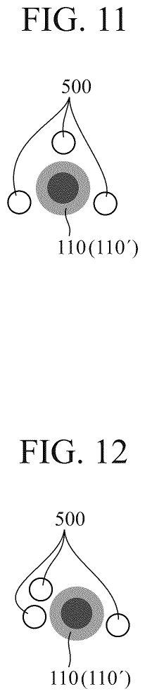

FIG. 11 is a view illustrating a first example of a touch state in the operation control device 300″ according to the third embodiment.

FIG. 12 is a view illustrating a second example of a touch state in the operation control device 300″ according to the third embodiment.

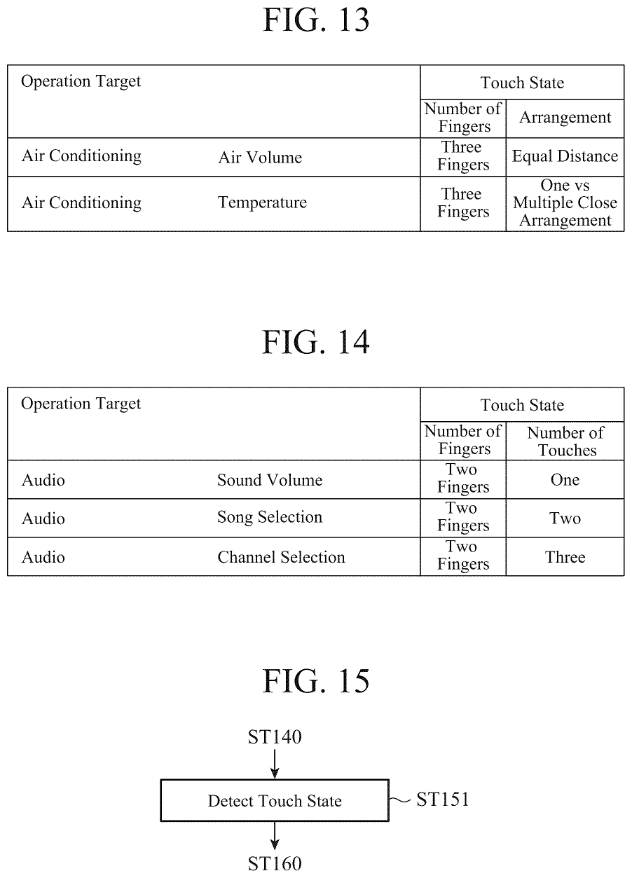

FIG. 13 is a first example of information stored in advance in the operation control device 300 according to the third embodiment, in which a touch state and an operation target are associated with each other.

FIG. 11 illustrates a touch state in which the number of touching fingers 500 is three and the positions of the fingers 500 are at equal distances from each other.

FIG. 12 illustrates a touch state (one vs multiple close contacts) in which three fingers 500 are touched, one finger of the three fingers 500 is separated from the other two fingers, and the two fingers are close to each other.

In this case, the storage unit 350″ stores information in which a touch state and an operation target are associated with each other as illustrated in FIG. 13.

FIG. 13 illustrates an example in which the touch state is “the number of fingers” and “arrangement of the fingers”.

Specifically, the operation target “air volume of air conditioning” is associated with the touch states “three fingers” and “equal distance”, and the operation target “air-conditioning temperature” is associated with the touch states “three fingers” and “one vs multiple close contacts”.

Accordingly, in a case of the touch state as illustrated in FIG. 11, the operation control device 300″ decides “air volume of air conditioning” as the operation target. Moreover, in a case of the touch state as illustrated in FIG. 12, the operation control device 300″ decides “air-conditioning temperature” as the operation target.

After deciding the operation target, an operation such as rotating the knob 110 is performed, so that the operation control device 300′ can change the numerical value indicating the “air volume of air conditioning” or change the numerical value indicating the “air-conditioning temperature”.

FIG. 14 is a second example of information stored in advance in the operation control device 300″ according to the third embodiment, in which a touch state and an operation target are associated with each other.

In a case where the touch state is a combination of the number of touch positions and the number of touches, information in which the touch state and the operation target are associated with each other as illustrated in FIG. 14 is stored in the storage unit 350′.

FIG. 14 illustrates an example in which the touch state is the “number of fingers” and the “number of touches” when the fingers are consecutively touched.

Specifically, the operation target “audio sound volume” is associated with the touch states “two fingers” and “one touch”. Moreover, the operation target “audio channel selection” and the touch states “two fingers” and “two touch times” are associated with each other. Furthermore, the operation target “audio channel selection” and “two fingers” and “three touch times” are associated with each other. Accordingly, for example, when accepting an operation such as tapping the display region with two fingers performed by the operator, the operation control device 300″ can decide one of a plurality of types of setting functions for audio.

Next, processing of the operation control device 300″ will be described.

FIG. 15 is a diagram illustrating a part of processing in the operation control device 300″ according to the third embodiment.

The processing of the operation control device 300″ according to the third embodiment is obtained by changing Step ST150 in the flowchart of FIG. 6 described in the first embodiment to Step ST151 illustrated in FIG. 15.

Hereinafter, Steps ST151 will be mainly described, and description of processing similar to the processing described in the first embodiment will be omitted.

When receiving the notification indicating the blind operation mode, the touch detection unit 320″ detects a touch state (Step ST151) and outputs, to the operation judgement unit 340, the touch state information indicating the touch state.

Specifically, the touch detection unit 320″ detects the above-described touch state.

Thereafter, the processing of the operation control device 300″ proceeds to Step ST160 illustrated in FIG. 6.

A modification example of the third embodiment will be described.

In the third embodiment, the configuration in which the knob-on touch display does not have the touch sensor is described above. However, as described in the second embodiment, the knob-on touch display may have a touch sensor 130.

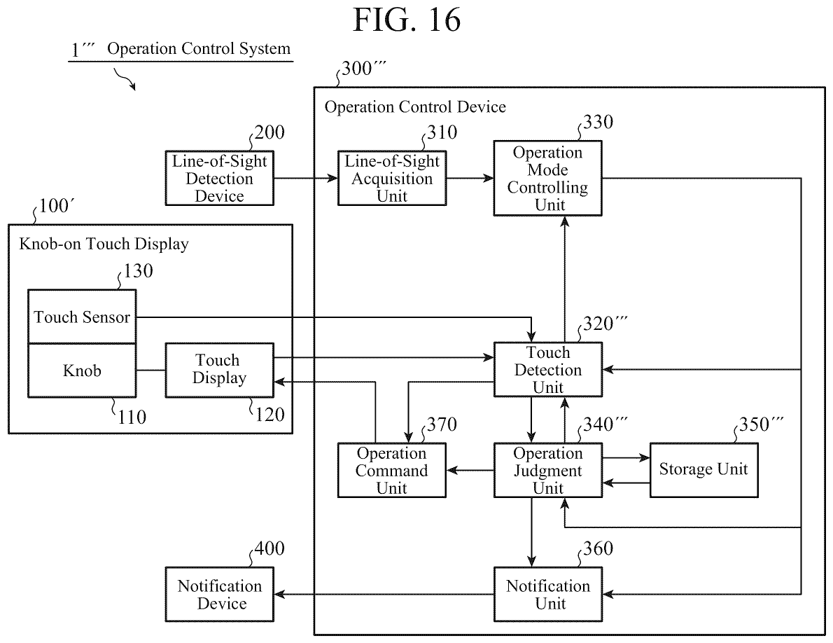

FIG. 16 is a diagram illustrating a configuration of an operation control system “including an operation control device 300” according to a modification example of the third embodiment.

The operation control system 1″ illustrated in FIG. 16 is different from the operation control system 1′ illustrated in FIG. 7 in that the operation control device 300′ is changed to the operation control device 300″′.

The operation control system l″ illustrated in FIG. 16 includes a knob-on touch display 100%, a line-of-sight detection device 200, the operation control device 300″″, and a notification device 400.

The knob-on touch display 100′, the line-of-sight detection device 200, the operation control device 300″′, and the notification device 400 illustrated in FIG. 16 are similar to the knob-on touch display 100%, the line-of-sight detection device 200, the operation control device 300, and the notification device 400 illustrated in FIG. 10, respectively, and thus description thereof is omitted.

The operation control device 300′ according to the modification example of the third embodiment further obtains effects similar to those of the operation control device 300 described in the second embodiment.

The processing of the operation control device 300′ is obtained by changing Step ST130 to Steps ST131 and ST132 illustrated in FIG. 9 and changing Step ST150 to Step ST151 illustrated in FIG. 15 in the flowchart of FIG. 6 described in the first embodiment. Since the processing is similar to the processing described above, a detailed description thereof will be omitted here.

In the operation control device of the present disclosure, the touch state is an arrangement state of a plurality of positions touched by the operator on the display region or the knob.

Accordingly, there is an effect that an operation control device, which decides an operation target from among more types of operation target candidates, can be provided.

Furthermore, in the operation control device of the present disclosure, the touch state is the number of times the display region or the knob is consecutively touched at a plurality of positions touched by the operator.

Accordingly, there is an effect that an operation control device, which decides an operation target from among more types of operation target candidates, can be provided.

A hardware configuration of the operation control devices 300, 300′, 300″ and 300″′ of the present disclosure will be described.

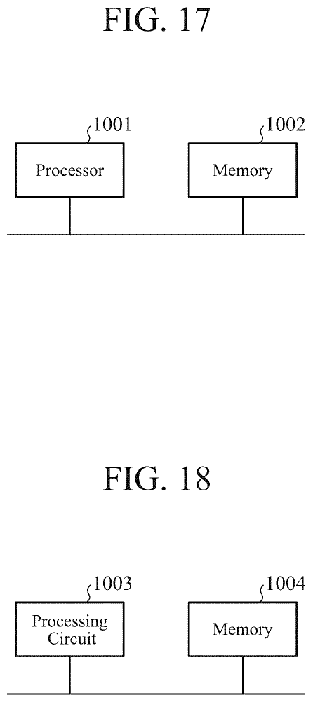

FIG. 17 is a diagram illustrating a first example of the hardware configuration for implementing the operation control device 300, 300′, 300″ and 300′ of the present disclosure.

FIG. 18 is a diagram illustrating a second example of the hardware configuration for implementing the operation control device 300, 300′, 300″ and 300″′ of the present disclosure.

Each of the operation control devices 300, 300′, 300″ and 300″′ according to the first embodiment, the second embodiment, the third embodiment, or the modification example of the third embodiment is implemented by hardware as illustrated in FIG. 17 or FIG. 18.

As illustrated in FIG. 17, each of the operation control devices 300, 300′, 300″ and 300″′ includes a processor 1001 and a memory 1002.

The processor 1001 and the memory 1002 are mounted on a computer, for example.

The memory 1002 stores programs for causing the computer to function as the line-of-sight acquisition unit 310, the touch detection units 320, 320′, 320″ and 320′, the operation mode controlling unit 330, the operation judgement units 340, 340′, 340″ and 340′″, the notification unit 360, the operation command unit 370, and the control unit (not illustrated). The processor 1001 reads out and executes the program stored in the memory 1002, thereby implementing the functions of the line-of-sight acquisition unit 310, the touch detection units 320, 320′, 320″ and 320″′, the operation mode controlling unit 330, the operation judgement units 340, 340′, 340″ and 340″′, the notification unit 360, the operation command unit 370, and the control unit (not illustrated).

Furthermore, the storage units 350, 350′, 350″ and 350″′ are implemented by the memory 1002 or another memory (not illustrated).

The processor 1001 uses, for example, a central processing unit (CPU), a graphics processing unit (GPU), a microprocessor, a microcontroller, a digital signal processor (DSP) or the like.

The memory 1002 may be a nonvolatile or volatile semiconductor memory such as a random access memory (RAM), a read only memory (ROM), an erasable programmable ROM (EPROM), an electrically erasable programmable read only memory (EEPROM), a flash memory or the like, may be a magnetic disk such as a hard disk or a flexible disk, may be an optical disk such as a compact disc (CD) or a digital versatile disc (DVD), or may be a magneto-optical disk.

Alternatively, the functions of the line-of-sight acquisition unit 310, the touch detection units 320, 320′, 320″ and 320″′, the operation mode controlling unit 330, the operation judgement units 340, 340′, 340″ and 340″′, the notification unit 360, the operation command unit 370, and the control unit (not illustrated) may be implemented by a dedicated processing circuit 1003 as illustrated in FIG. 18. In this case, the storage unit 350 is implemented by a memory 1004 or another memory (not illustrated).

The processing circuit 1003 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Note that the functions of the line-of-sight acquisition unit 310, the touch detection units 320, 320′, 320″ and 320′″, the operation mode controlling unit 330, the operation judgement units 340, 340′, 340″ and 340″′, the notification unit 360, the operation command unit 370, and the control unit (not illustrated) may be implemented by different processing circuits, or may be collectively implemented by a processing circuit.

Alternatively, some of the functions of the line-of-sight acquisition unit 310, the touch detection units 320, 320′, 320″ and 320″′, the operation mode controlling unit 330, the operation judgement units 340, 340′, 340″ and 340″′, the notification unit 360, the operation command unit 370, and the control unit (not illustrated) may be implemented by the processor 1001 and the memory 1002, and the remaining functions may be implemented by the processing circuit 1003.

Note that, in the scope of the present invention, the present disclosure allows free combinations of each embodiment, modification of any constituents of each embodiment, or omission of any constituents in each embodiment.

### INDUSTRIAL APPLICABILITY

In a case where the operation control device according to the present disclosure detects a touch state in a state where the line-of-sight of the operator is not directed to the touch display, the operation control device decides an operation target to be touched depending on the detected touch state. Therefore, the operation control device according to the present disclosure is suitable for use in an operation control device or the like of an in-vehicle knob-on touch display.

### REFERENCE SIGNS LIST

1, 1′, 1″′, 1′″: operation control system, 100, 100′: knob-on touch display, 110; knob, 120: touch display, 120a: display region, 130: touch sensor, 151, 152, 153; detection range, 200: line-of-sight detection device, 300, 300′ 300″, 300″′: operation control device, 310: line-of-sight acquisition unit, 320, 320′, 320″, 320″′: touch detection unit, 330; operation mode controlling unit, 340, 340′, 340″, 340″′: operation judgement unit, 350, 350′, 350″, 350″′: storage unit, 360: notification unit, 370; operation command unit, 400: notification device, 500: finger, 1001: processor, 1002: memory, 1003: processing circuit, 1004: memory

1. An operation control device, comprising:
processing circuitry configured to
acquire, from a line-of-sight detection device, line-of-sight information indicating a line-of-sight of an operator on a touch display;
detect a first touch state that indicates a physical touch by the operator on a display region of the touch display or a second touch state that indicates a physical touch by the operator on a knob for operation disposed in the display region; and
decide an operation target by touch depending on the detected first or second touch state with reference to information, stored in advance, in which the first and second touch states and the operation target are associated with each other in a case where the first or second touch state is detected in a state in which the line-of-sight of the operator indicated in the acquired line-of-sight information is not directed toward the touch display.

2. The operation control device according to claim 1, wherein
the processing circuitry detects the first touch state in which the operator touches the knob by using a signal from a touch sensor provided on the knob and detects the second touch state in which the operator touches the display region of the touch display, and
decides the operation target based on the second touch state on the display region in a case where the second touch state j detected on the display region after the first touch state is detected on the knob.

3. The operation control device according to claim 2, wherein
the processing circuitry does not adopt the second touch state on the display region of the touch display, other than a partial region of the touch display including a region in which the knob is disposed, when acquiring, the first touch state in which the operator touches the knob in a state in which the line-of-sight of the operator is not directed toward the touch display.

4. The operation control device according to claim 1, wherein
the first touch state and the second touch state includes a position touched by the operator on the display region the knob, restively.

5. The operation control device according to claim 1, wherein
the first touch state and the second touch state includes a number of positions touched by the operator on the display region and the knob, respectively.

6. The operation control device according to claim 1, wherein
the first touch state and the second touch state includes a pressure for each of positions touched by the operator on the display region and the knob, respectively.

7. The operation control device according to claim 1, wherein
the first touch state and the second touch state includes an area for each of positions touched by the operator on the display region and the knob, respectively.

8. The operation control device according to claim 1, wherein
the first touch state and the second touch state includes a number of times that the operator touches consecutively on the display region and the knob, respectively.

9. The operation control device according to claim 1, wherein
the first touch state and the second touch state includes an arrangement state of a plurality of positions touched by the operator on the display region and the knob, respectively.

10. The operation control device according to claim 1, wherein
the first touch state and the second touch state includes a number of times that the operator touches consecutively at a plurality of positions touched by the operator on the display region and the knob, respectively.

11. The operation control device according to claim 1,
wherein the processing circuitry is further configured to
output an operation command signal related to the operation target depending on the first or second touch state having been detected when the operation target is decided.

12. The operation control device according to claim 1,
wherein the processing circuitry is further configured to
output a notification signal for notifying the operator of the decided operation target.

13. The operation control device according to claim 12, wherein
the processing circuitry outputs the notification signal for vibrating the touch display when the operation target is decided and the operation target changes.

14. The operation control device according to claim 12, wherein
the processing circuitry outputs the notification signal for displaying the decided operation target on a head-up display mounted on a vehicle.

15. The operation control device according to claim 1, wherein
the operation target includes a function of an in-vehicle equipment and a function of changing a numerical value to large or small.

16. The operation control device according to claim 15, wherein
the operation target includes a function of setting at least one of temperature setting for air conditioning equipment, sound volume setting for acoustic equipment, channel selection for broadcast receiving equipment, or brightness of illumination.

17. An operation control system, comprising:
a touch display for a vehicle;
a display region of the touch display or a knob for operation disposed in the display region; and
an operation control device to command an operation target depending on a first touch state that indicates a physical touch by the operator on the display region of the touch display or a second touch state that indicates a physical touch by the operator on the knob, wherein
the operation control device includes:
processing circuitry configured to
acquire line-of-sight information indicating a line-of-sight of the operator on the touch display from a line-of-sight detection device;
detect the first or second touch state in which the operator touches the display region of the touch display or the knob; and
decide an operation target by touch depending on the detected first or second touch state with reference to information, stored in advance, in which the first and second touch states and the operation target are associated with each other in a case where the first or second touch state is detected in a state in which the line-of-sight of the operator indicated in the acquired line-of-sight information is not directed toward the touch display.

18. An operation control method for an operation control device to command an operation target depending on a first touch state that indicates a physical touch by an operator on a display region of a touch display or a second touch state that indicates a physical touch by the operator on a knob disposed in the display region, comprising:
acquiring line-of-sight information indicating a line-of-sight of the operator of the touch display from a line-of-sight detection device;
detecting the first or second touch state in which the operator touches the display region of the touch display or the knob; and
deciding an operation target by touch depending on the detected first or second touch state with reference to information, stored in advance, in which the first and second touch states is associated with the operation target in a case where the first or second touch state 1a detected in a state in which the line-of-sight of the operator indicated in the acquired line-of-sight information is not directed toward the touch display.
